(19) United States
(12) Patent Application Publication
(10) Pub. No.: US 2016/0325787 A1
(43) Pub. Date: Nov. 10, 2016

(54) COWL LOUVER ANCHORING STRUCTURE

(71) Applicant: TOYOTA JIDOSHA KABUSHIKI KAISHA, Toyota-shi, Aichi (JP)

(72) Inventor: Katsuya MATSUMURA, Toyota-shi (JP)

(73) Assignee: TOYOTA JIDOSHA KABUSHIKI KAISHA, Toyota-shi, Aichi-ken (JP)

(21) Appl. No.: 15/026,297

(22) PCT Filed: Dec. 5, 2014
(86) PCT No.: PCT/JP2014/082909

§ 371 Date: Mar. 31, 2016

(30) Foreign Application Priority Data
Jan. 23, 2014 (JP) 2014-010815

(51) Int. Cl. B62D 25/08

(52) U.S. Cl. CPC B62D 25/081; B60R 21/34

(57) ABSTRACT

A cowl louver anchoring structure with a cowl louver main body that is disposed along a vehicle transverse direction at a lower end portion side of a front windshield; an accommodating portion that is fixed to the lower end portion side of the front windshield, and whose vertical cross-section along a vehicle longitudinal direction is U-shaped; a mounting portion that is provided at a rear end side of the cowl louver main body, and that is anchored to the accommodating portion by being inserted into the accommodating portion; a plurality of anchor convex portions that are provided at the mounting portion, along a direction of assembling the mounting portion to the accommodating portion and plurality of anchored-on convex portions that are provided at the accommodating portion along the direction of assembling the mounting portion to the accommodating portion and on which the plural anchor convex portions are anchored respectively.

### TECHNICAL FIELD

The present invention relates to a cowl louver anchoring structure.

### BACKGROUND ART

A structure has been proposed in which, in a vehicle, a molding is interposed in the gap between the rear end portion of a cowl louver and the lower end portion of a front windshield, and the cowl louver is anchored to the lower end side of the front windshield by being anchored on the molding (refer to Japanese Patent Application Laid-Open (JP-A) No. 2010-264868).

Concretely, an accommodating portion that is U-shaped in cross-section is formed at the other end portion side of a molding whose one end is fixed to the reverse surface side of the lower end portion of the front windshield. A mounting portion provided at the rear end of the cowl louver is inserted in the accommodating portion, and, due to anchor convex portions of the mounting portion being anchored on anchored-on convex portions of the accommodating portion, the cowl louver is anchored to the molding.

Note that, in recent years, from the standpoint of protecting head portions of pedestrians, cowl louvers have been structured so as to come apart from the molding in cases in which a predetermined impact force is applied to the cowl louver.

### SUMMARY OF INVENTION

### Technical Problem

However, because the anchor convex portions of the mounting portions are provided at portions at a uniform interval in the vehicle transverse direction, the thickness, in the vehicle transverse direction, of the anchor convex portions of the mounting portion is thin, and the surface area of abutment between the anchored-on convex portions and the anchor convex portions at the time of anchoring is small. Therefore, the extraction load of the cowl louver with respect to the molding is small.

In consideration of the above-described circumstances, the present invention provides a cowl louver anchoring structure whose extraction load is stable.

### Solution to Problem

In accordance with a first aspect of the present invention, a cowl louver anchoring structure includes: a cowl louver main body that is disposed along a vehicle transverse direction at a lower end portion side of a front windshield; an accommodating portion that is fixed to the lower end portion side of the front windshield, and whose vertical cross-section along a vehicle longitudinal direction is U-shaped; a mounting portion that is provided at a rear end side of the cowl louver main body, and that is anchored to the accommodating portion by being inserted into the accommodating portion; a plurality of anchor convex portions that are provided at the mounting portion, along a direction of assembling the mounting portion to the accommodating portion; and plural anchored-on convex portions that are provided at the accommodating portion along the direction of assembling the mounting portion to the accommodating portion, and on which the plural anchor convex portions are anchored respectively.

In the cowl louver anchoring structure in accordance with the first aspect of the present invention, due to the mounting portion, that is provided at the rear end side of the cowl louver main body, being inserted into the accommodating portion that is fixed to the lower end portion side of the front windshield and whose cross-section along the vehicle longitudinal direction is U-shaped, the mounting portion is anchored to the accommodating portion. Here, the plural anchored-on convex portions are formed at the accommodating portion along the direction of assembling the mounting portion to the accommodating portion, and the plural anchor convex portions are provided at the mounting portion. Namely, there is a structure in which, when impact force is applied to the cowl louver main body, the plural anchor convex portions abut the plural anchored-on convex portions respectively. Therefore, the surface area of abutment of the anchor convex portions with respect to the anchored-on convex portions increases, and the extraction load of the cowl louver with respect to the accommodating portion is large. Namely, when load that is less than or equal to a predetermined amount is applied to the cowl louver main body, the cowl louver main body coming-out from the accommodating portion is prevented or suppressed.

In accordance with a second aspect of the present invention, in the first aspect of the present invention, an anchor surface of at least one anchor convex portion, and an anchored-on surface of the anchored-on convex portion to which the anchor surface is adjacent, may be parallel to a top surface of the cowl louver main body or may be inclined frontward while heading downward.

In this cowl louver anchoring structure, when extraction load is applied to the cowl louver main body, the anchor surfaces of the anchor convex portions of the mounting portion of the cowl louver main body, and the anchored-on surfaces of the adjacent anchored-on convex portions of the accommodating portion, abut one another. At this time, the extraction load is applied in a direction orthogonal to the top surface of the cowl louver main body. Therefore, if at least one anchor surface and anchored-on surface are parallel to the top surface of the cowl louver main body or are inclined forward while heading downward, it is difficult for the anchor portions to come-out from the anchored-on portions, and the extraction load increases. Namely, when load that is less than or equal to a predetermined amount is applied to the cowl louver main body, the cowl louver main body coming-out from the accommodating portion is prevented or suppressed.

In accordance with a third aspect of the present invention, in the first or second aspect of the present invention at least one of the anchor convex portions or the anchored-on convex portions may be formed at portions in the vehicle transverse direction.

At least one of the anchor convex portions of the mounting portion or the anchored-on convex portions of the accommodating portion are formed at portions in the vehicle transverse direction with respect to the cowl louver main body that extends in the vehicle transverse direction. Therefore, assembly of the cowl louver is easy. Further, the plural anchor convex portions and the plural anchored-on convex portions are provided along the direction of assembling the mounting portion to the accommodating portion, and the surface area of abutment of the anchor convex portions and the anchored-on convex portions is increased. Therefore, the extraction load can be increased effectively.

In accordance with a fourth aspect of the present invention, in the second or third aspect of the present invention, a distance, in a direction orthogonal to the top surface of the cowl louver main body, between anchor surfaces of the plural anchor convex portions and anchored-on surfaces of the plural anchored-on convex portions that are adjacent to the anchor surfaces may become greater further toward a top surface side of the cowl louver main body.

In this cowl louver anchoring structure, the distance, in a direction orthogonal to the top surface of the cowl louver main body, between the anchor surfaces of the anchor convex portions of the cowl louver main body and the anchored-on surfaces of the anchored-on convex portions of the accommodating portion, which anchored-on surfaces are adjacent to these anchor surfaces, becomes greater further toward the top surface side of the cowl louver main body. Accordingly, when the cowl louver main body is anchored to the accommodating portion, the anchor convex portions cross-over the anchored-on convex portions and anchor on these anchored-on convex portions, from the anchor convex portion at the deep side of the accommodating portion. Namely, if the anchor convex portion that is nearest to the top surface side is anchored on the anchored-on convex portion of the accommodating portion, the other anchor convex portions are anchored on the respective anchored-on convex portions.

Accordingly, merely by confirming the anchored state of the anchor convex portion and the anchored-on convex portion that are at the outermost portion (the top surface side) of the cowl louver main body, it can be confirmed that the other anchor convex portions and anchored-on convex portions are in anchored states.

### Advantageous Effects of Invention

Because the present invention is structured as described above, the extraction load of the cowl louver main body from the accommodating portion is stable.

### BRIEF DESCRIPTION OF DRAWINGS

FIG. 1 is a vertical sectional view of a vehicle front portion structure to which a cowl louver anchoring structure relating to an embodiment of the present invention is applied.

FIG. 2 is a vertical sectional view in a vehicle longitudinal direction, showing the cowl louver anchoring structure relating to the embodiment of the present invention.

FIG. 3 is a vertical sectional view in the vehicle longitudinal direction, showing an anchored state at the cowl louver anchoring structure relating to the embodiment of the present invention.

FIG. 4 is a vertical sectional view showing deformation after impact is applied from a head portion impactor to the vehicle front portion structure to which the cowl louver anchoring structure relating to the embodiment of the present invention is applied.

### DESCRIPTION OF EMBODIMENTS

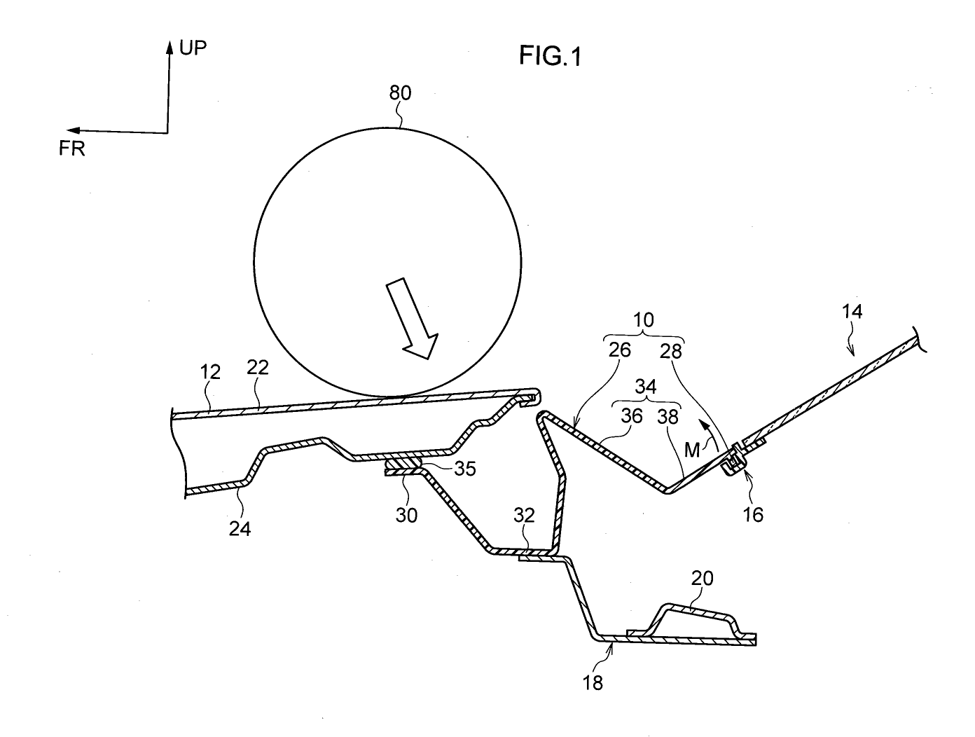

A cowl louver anchoring structure relating to an embodiment of the present invention is described with reference to FIG. 1 through FIG. 4. Hereinafter, arrow FR in the respective drawings indicates the vehicle front side, and arrow UP indicates the vehicle upper side. Note that illustration of members that are not related to the gist of the present invention is omitted.

FIG. 1 is a vertical section view in which the vicinity of a cowl louver is cut along a vehicle longitudinal direction, at a vehicle to which the cowl louver anchoring structure is applied. As shown in FIG. 1, a cowl louver 10 is disposed between a hood panel 12 of a vehicle body and a front windshield 14 that is disposed at a predetermined interval at the vehicle rear side of the hood panel 12. The cowl louver 10 is anchored to the front windshield 14 via a molding 16 that is described later.

Further, a cowl panel 18 is disposed at the vehicle lower side of the cowl louver 10. The cowl panel 18 is, at the vehicle rear side end portion, fixed to a vehicle body (body) 20.

The hood panel 12 is formed of a steel plate, and has an outer panel 22 and an inner panel 24. The inner panel 24 is disposed at the vehicle lower side of the outer panel 22. The outer panel 22 and the inner panel 24 are connected at the vehicle rear side end portions thereof.

The cowl louver 10 has a main body portion 26 and a mounting portion 28. The cowl louver 10 is made of a hard resin (e.g., a PP resin), and is formed along the entire length in the vehicle transverse direction (the direction orthogonal to the surface of the drawing). As shown in FIG. 1, the main body portion 26 has, from the hood panel 12 side toward the front windshield 14 side, a hood panel side sealing portion 30, a cowl panel side fixing portion 32, and a cover portion 34.

The hood panel side sealing portion 30 is disposed beneath the inner panel 24 of the hood panel 12. The gap between the hood panel 12 and the cowl louver 10 (the main body portion 26) is sealed due to a resin part 35 that is soft being interposed in a press-contacting state between the inner panel 24 and the vehicle front side end portion of the hood panel side sealing portion 30.

The cowl panel side fixing portion 32, that is formed at the vehicle rear side of the hood panel side sealing portion 30, is joined to the vehicle front side end portion of the cowl panel 18.

The cover portion 34 that is disposed at the vehicle rear side of the cowl panel side fixing portion 32 has, from the cowl panel side fixing portion 32 side, a protruding portion 36 that protrudes toward the vehicle upper side and the vehicle front side, and a rear end portion 38 that extends from the vehicle rear side end portion of the protruding portion 36 toward the front windshield 14 in a direction parallel to the front windshield 14.

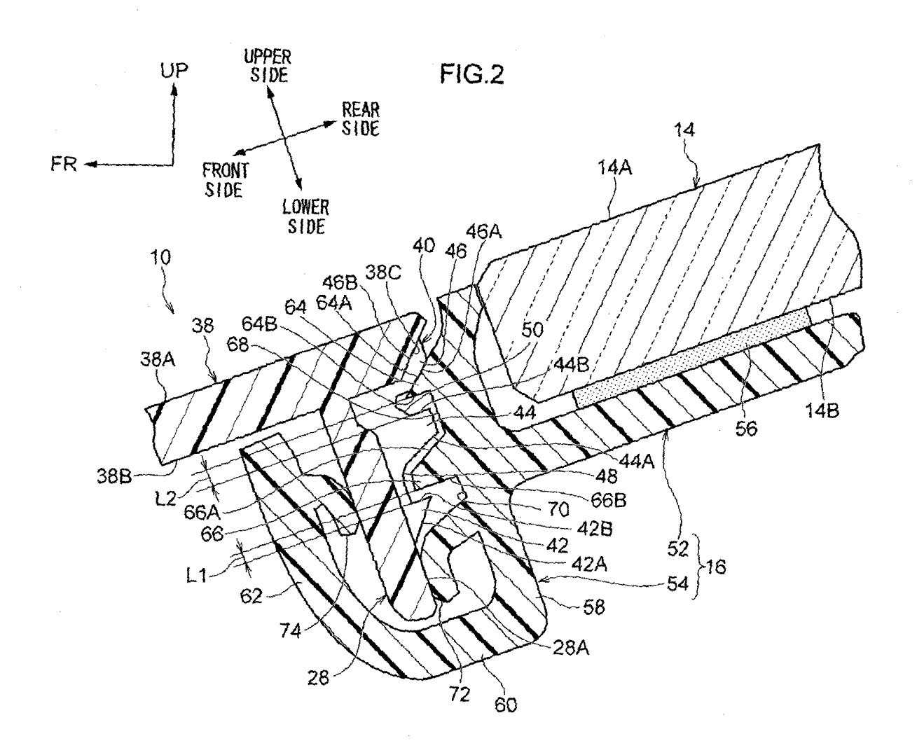

FIG. 2 is an enlarged view showing the vicinity of the rear end (the mounting portion 28) of the rear end portion 38 of the cowl louver 10. Note that, in the following description, the direction, that is orthogonal to the vehicle transverse direction and is parallel to the front windshield 14 (a top surface 38A of the rear end portion 38 of the cowl louver 10), is defined as the longitudinal direction, and the direction, that is orthogonal to the vehicle transverse direction and is orthogonal to the front windshield 14 (the top surface 38A of the rear end portion 38) is defined as the vertical direction. Further, of the longitudinal direction, the direction heading from the front windshield 14 toward the cowl louver 10 side is defined as the front side, and the direction heading from the cowl louver 10 toward the front windshield 14 is defined as the rear side. Further, the direction heading from the surface of the front windshield 14 that faces the vehicle cabin side (the bottom surface) toward the surface that faces the vehicle outer side (the top surface) is defined as the upper side, and the direction heading from the top surface toward the bottom surface is defined as the lower side.

As shown in FIG. 2, the rear end portion 38 of the cover portion 34 has the top surface 38A that faces toward the vehicle outer side, a bottom surface 38B that faces toward the vehicle cabin side, and, at the rear end portion thereof, an inclined surface 38C for abutment.

As shown in FIG. 2, the mounting portion 28 is formed at the rear end portion 38 of the cowl louver 10. The mounting portion 28 is formed so as to project orthogonally downward from the bottom surface 38B of the rear end portion 38, and extends along the entire length in the vehicle transverse direction. Plural, elastically-deformable anchor portions 40 are formed at a uniform interval in the vehicle transverse direction at a rear side surface 28A of the mounting portion 28. The anchor portion 40 has a first convex portion 42 and a second convex portion 44 that project rearward from the lower side, and an abutment portion 46 that is interposed between the rear end portion 38 of the cover portion 34 and the molding 16 that is described later. Further, a first concave portion 48 is formed between the first convex portion 42 and the second convex portion 44, and a second concave portion 50 is formed between the second convex portion 44 and the abutment portion 46.

An inclined surface 42A, that is inclined forward while heading downward, is formed at the lower side of the first convex portion 42. Further, an anchor surface 42B that is formed parallel to the longitudinal direction is formed at the upper side of the first convex portion 42.

An inclined surface 44A, that is inclined forward while heading downward, is formed at the lower side of the second convex portion 44. Further, an anchor surface 44B that is formed parallel to the longitudinal direction is formed at the upper side of the second convex portion 44.

Moreover, inclined surfaces 46A, 46B, that are inclined rearward while heading upward and that are substantially parallel to the inclined surface 38C of the rear end portion 38 of the cowl louver 10, are formed at the lower side and upper side of the abutment portion 46.

On the other hand, as shown in FIG. 2, the molding 16 has a mounting portion 52 that extends parallel to the front windshield 14, and an accommodating portion 54 that is substantially U-shaped in cross-section and is formed continuously from the front end portion of the mounting portion 52 and accommodates and anchors the mounting portion 28 of the cowl louver 10.

The mounting portion 52 of the molding 16 is fixed parallel to the front windshield 14 via double-sided tape 56 at the lower end portion of a bottom surface 14B of the front windshield 14.

The accommodating portion 54 has a rear surface portion 58 that is continuous with the mounting portion 52 and extends in the vertical direction, a bottom surface portion 60 that extends frontward from the lower end of the rear surface portion 58, and a front surface portion 62 that extends upward from the front end of the bottom surface portion 60. The accommodating portion 54 is formed in a U-shape in cross-section overall.

The upper end of the rear surface portion 58 is disposed between the front end of the front windshield 14 and the rear end portion 38 of the cowl louver 10, and a first convex portion 64 and a second convex portion 66 that project forward from the upper side are formed thereat. Further, a first concave portion 68 is formed between the first convex portion 64 and the second convex portion 66, and a second concave portion 70 is formed between the second convex portion 66 and the bottom surface portion 60. Moreover, an inclined surface 64A, that is formed parallel to the inclined surface 38C of the rear end portion 38, is formed at the upper side of the first convex portion 64, and an anchored-on surface 64B, that is formed parallel to the longitudinal direction, is formed at the lower side of the first convex portion 64. Further, an inclined surface 66A, that is inclined rearward while heading upward, is formed at the upper side of the second convex portion 66, and an anchored-on surface 66B, that is formed parallel to the longitudinal direction, is formed at the lower side of the second convex portion 66.

Further, a first tongue piece 72 that is flexible is formed to project out at the front side (the accommodating portion inner side) from the second concave portion 70 of the rear surface portion 58. Moreover, a second tongue piece 74 that is flexible is formed so as to project out at the rear side (the accommodating portion inner side) of the front surface portion 62. Due to the mounting portion 28 being inserted into the accommodating portion 54 at the time of assembly, these tongue pieces 72, 74 are pushed and bent downward, and hold (fix) the mounting portion 28 by the elastic forces thereof.

Operation of the cowl louver anchoring structure that is formed in this way is described.

First, the case of assembling the cowl louver 10 to the molding 16 is described. Concretely, the mounting portion 28 that is provided at the rear end portion 38 of the cowl louver 10 is inserted into the accommodating portion 54 of the molding 16.

At this time, due to the respective inclined surfaces 42A, 44A of the first convex portion 42 and the second convex portion 44 of the anchor portions 40, that are formed at a predetermined interval in the vehicle transverse direction of the mounting portion 28, being guided by the inclined surfaces 64A, 66A of the accommodating portion 54, the inclined surfaces 42A, 44A ride-over the first convex portion 64 and the second convex portion 66 of the molding 16 and are inserted into the interior. At this time, due to the flexible first tongue piece 72 and second tongue piece 74 of the accommodating portion 54 being pushed and bent and the mounting portion 28 being inserted into the accommodating portion 54, the mounting portion 28 is fixed by the elastic forces of the first tongue piece 72 and the second tongue piece 74.

On the other hand, insertion of the mounting portion 28 is stopped due to the inclined surfaces 46A of the abutment portions 46 of the anchor portions 40 abutting the inclined surface 64A of the accommodating portion 54. As a result, the anchor surfaces 42B of the first convex portions 42 of the anchor portions 40, that have ridden-over the second convex portion 66 of the accommodating portion 54 and have been inserted into the second concave portion 70, and the anchored-on surface 66B of the second convex portion 66 of the accommodating portion 54, are disposed so as to face one another with gap L1 therebetween (see FIG. 2). The anchor surfaces 44B of the second convex portions 44 of the anchor portions 40, that have ridden-over the first convex portion 64 of the accommodating portion 54 and have been inserted into the first concave portion 68, and the anchored-on surface 64B of the first convex portion 64 of the accommodating portion 54, are disposed so as to face one another with gap L2 therebetween (see FIG. 2). Here, the gap L2 that is near to the top surface 38A of the rear end portion 38 is larger than the gap L1.

Because the gap L2 is set to be larger than the gap L1 in this way, when the second convex portions 44 of the anchor portions 40 have crossed-over the first convex portion 64 of the accommodating portion 54 and are inserted into the first concave portion 68, the first convex portions 42 of the anchor portions 40 have crossed-over the second convex portion 66 of the accommodating portion 54 and are reliably inserted into the second concave portion 70.

Accordingly, in order to confirm the assembled state, the anchored state of the first convex portions 42 of the anchor portions 40 and the second convex portion 66 of the accommodating portion 54 can be confirmed merely by confirming the anchored state of the second convex portions 44 of the anchor portions 40 and the first convex portion 64 of the accommodating portion 54 by pressing the rear end portion 38 of the cowl louver 10, or the like.

Operation in a case in which impact force is applied to the cowl louver 10 is described next.

As shown in FIG. 1, a head portion impactor 80 is made to collide with the rear end side of the hood panel 12 from the direction of the arrow.

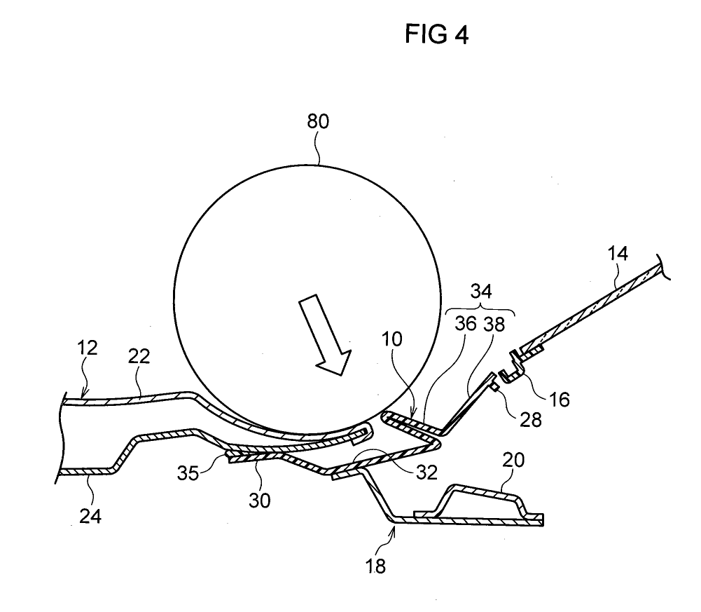

As a result, as shown in FIG. 4, the head portion impactor 80 pushes and bends the rear end side of the hood panel 12, and also pushes and bends the cowl louver 10. Concretely, the protruding portion 36 is crushed, and a rotation moment M is applied to the rear end portion 38 that is connected to the protruding portion 36 (see FIG. 1).

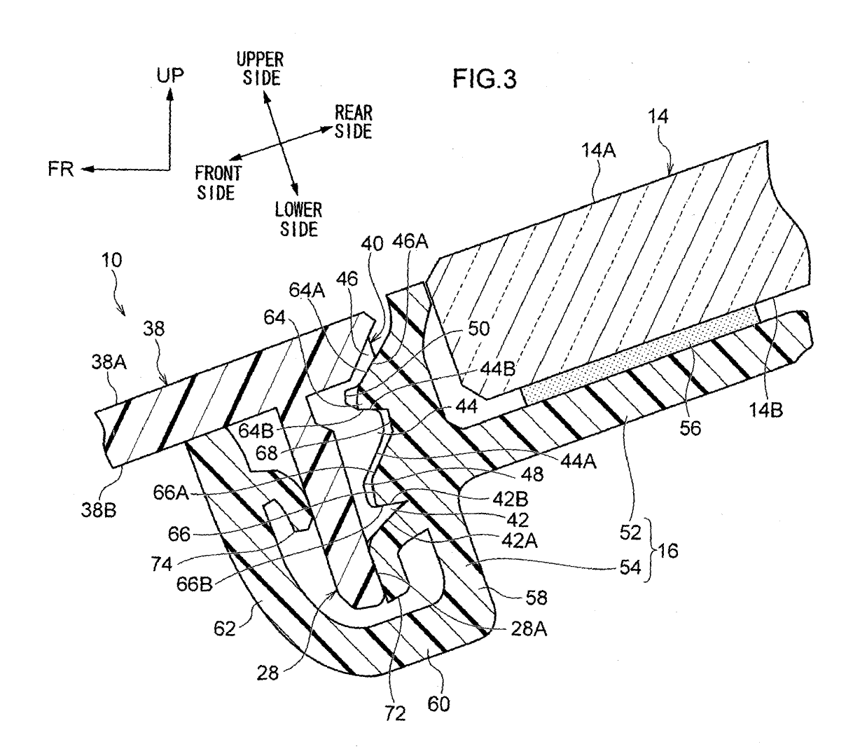

When the rotation moment M is applied to the rear end portion 38 of the cowl louver 10, as shown in FIG. 3, the anchor surfaces 42B, 44B of the first convex portions 42 and the second convex portions 44 of the anchor portions 40 of the mounting portion 28 abut the anchored-on surfaces 66B, 64B of the second convex portion 66 and the first convex portion 64 of the accommodating portion 54, respectively.

Because the anchor surfaces 42B, 44B and the anchored-on surfaces 66B, 64B are provided in two steps along the direction of assembling the mounting portion 28 (the vertical direction that is orthogonal to the top surface 38A of the rear end portion 38), the surface area of abutment in the anchored state is sufficiently ensured. Accordingly, when impact force that is less than or equal to a predetermined impact force is applied to the cowl louver 10, the first convex portions 42 and the second convex portions 44 of the anchor portions 40 ride-over the second convex portion 66 and the first convex portion 64 of the accommodating portion 54, and the mounting portion 28 coming-out from the accommodating portion 54 is prevented or suppressed.

Here, when impact force that is greater than or equal to the predetermined impact force is transmitted to the cowl louver 10, as shown in FIG. 4, the mounting portion 28 comes-out of the molding 16 (the accommodating portion 54).

In this way, the cowl louver 10 of the present embodiment is structured such that the first convex portions 42 and the second convex portions 44 that are at two steps in the vertical direction are provided at the mounting portion 28, and respectively anchor on the second convex portion 66 and the first convex portion 64 that are provided at the accommodating portion 54 at two steps in the vertical direction. Therefore, the extraction load of the cowl louver 10 with respect to the accommodating portion 54 is sufficiently large. Accordingly, the cowl louver 10 (the mounting portion 28) coming-out and coming apart from the accommodating portion 54 at an impact force that is weaker than the predetermined impact force is prevented or suppressed.

Note that, at the cowl louver 10 of the present embodiment, the anchor portions 40 are formed at a predetermined interval in the vehicle transverse direction, i.e., are formed at portions in the vehicle transverse direction. Therefore, even if the surface area of abutment is increased merely by varying the cross-sectional shapes of an anchor surface of the anchor portion 50 and an anchored-on surface of the accommodating portion 54, the effects thereof are limited. Even in such a case, the present invention can sufficiently ensure the surface area of abutment, and is therefore effective.

Further, because the anchor surfaces 42B, 44B of the cowl louver 10 and the anchored-on surfaces 64B, 66B of the accommodating portion 54 are formed parallel to the longitudinal direction (the top surface 38A of the cowl louver 10), it is difficult to cancel the anchored state in which the anchor surfaces 42B, 44B abut the anchored-on surfaces 64B, 66B. Concretely, it is difficult to cancel the anchored state as compared with a case in which the anchor surfaces 42B, 44B and the anchored-on surfaces 64B, 66B are surfaces that are inclined rearward while heading downward (are tapered surfaces). Accordingly, the cowl louver 10 coming-out and coming apart from the accommodating portion 54 at an impact force that is weaker than the predetermined impact force is prevented or suppressed.

Note that, in the present embodiment, the anchor surfaces 42B, 44B of the cowl louver 10 and the anchored-on surfaces 64B, 66B of the accommodating portion 54 are formed parallel to the longitudinal direction, but may be surfaces that are inclined forward while heading downward (may be reversely tapered surfaces).

Further, both the set of the anchor surface 42B and the anchored-on surface 66B, and the set of the anchor surface 44B and the anchored-on surface 64B are made to be parallel to the longitudinal direction, but it suffices for either one set to be parallel or reversely tapered.

Further, by providing the first convex portion 42 and the second convex portion 44 at the mounting portion 28, and providing the first convex portion 64 and the second convex portion 66 at the accommodating portion 54, in two steps along the direction of assembling the mounting portion 28 (the vertical direction), the extraction load of the cowl louver 10 from the molding 16 is made to be large. However, the convex portions may be provided in three or more plural steps along the direction of insertion of the mounting portion 28.

Moreover, although the anchor portions 40 are formed at portions (at a predetermined interval) in the vehicle transverse direction in the present embodiment, the present invention may be applied to a structure in which the anchor portion 40 is formed along the entire length in the vehicle transverse direction.

Still further, although the anchor portions 40 are formed at portions in the vehicle transverse direction in the present embodiment, the first convex portions 64 and the second convex portions 66 of the accommodating portion 54 may be formed at portions in the vehicle transverse direction.

Further, in the present embodiment, the anchor portion 40 and the first convex portion 64 and the second convex portion 66 are formed at the rear side of the mounting portion 28, but moreover may be formed at the front side.

The disclosure of Japanese Patent Application No. 2014-010815, filed Jan. 23, 2014, is incorporated herein by reference in its entirety. All publications, patent applications, and technical standards mentioned in this specification are herein incorporated by reference to the same extent as if each individual publication, patent application, or technical standard was specifically and individually indicated to be incorporated by reference.

1. A cowl louver anchoring structure comprising:
a cowl louver main body that is disposed along a vehicle transverse direction at a lower end portion side of a front windshield;
an accommodating portion that is fixed to the lower end portion side of the front windshield, and whose vertical cross-section along a vehicle longitudinal direction is U-shaped;
a mounting portion that is provided at a rear end side of the cowl louver main body, and that is anchored to the accommodating portion by being inserted in the accommodating portion;
a plurality of anchor convex portions that are provided at the mounting portion along a direction of assembling the mounting portion to the accommodating portion; and
a plurality of anchored-on convex portions that are provided at the accommodating portion along the direction of assembling the mounting portion to the accommodating portion, and on which the plurality of anchor convex portions are anchored respectively,
wherein a distance, in a direction orthogonal to a top surface of the cowl louver main body, between anchor surfaces of the plurality of anchor convex portions and anchored-on surfaces of the plurality of anchored-on convex portions that are adjacent to the anchor surfaces becomes greater, the further toward a top surface side of the cowl louver main body.

2. The cowl louver anchoring structure of claim 1, wherein an anchor surface of at least one anchor convex portion, and an anchored-on surface of the anchored-on convex portion to which the anchor surface is adjacent, are parallel to a top surface of the cowl louver main body or are inclined frontward while heading downward.

3. The cowl louver anchoring structure of claim 1, wherein, of the anchor convex portions and the anchored-on convex portions, at least one of the convex portions are formed at portions in the vehicle transverse direction.

4. (canceled)

5. The cowl louver anchoring structure of claim 2, wherein, of the anchor convex portions and the anchored-on convex portions, at least one of the convex portions are formed at portions in the vehicle transverse direction.
